(19) United States
(12) Patent Application Publication
(10) Pub. No.: US 2003/0190393 A1
(43) Pub. Date: Oct. 9, 2003

(54) Flexible food seal

(76) Inventors: Karen A. Johnson, Azusa, CA (US); James A. Johnson, Azusa, CA (US)

Correspondence Address: Donald W. Meeker, 750 La Playa, #512, San Francisco, CA, 94121, US

(21) Appl. No.: 10/119,967

(22) Filed: Apr. 9, 2002

(51) Int. Cl. A23L 1/00

(52) U.S. Cl. 426/418

(57) ABSTRACT

Seals of see-through air-tight flexible bendable material are cut to conform to the shape and size of food storage containers. A seal is placed over the top surface of food in a food storage container. The seal is pressed down and smoothed out removing all of the air bubbles, visible through the seal. The edges of the seal are pressed against the sides of the container to conform to the shape of the container and smoothed out to remove any air spaces between the seal and the container. Multiple seals may be cut simultaneously from multiple sheets using a cutting die or laser cutter. The seals may be cut and packaged in quantity.

### BACKGROUND OF THE INVENTION

1. Field of the Invention

The present invention relates to devices and storage containers for food preservation and in particular to a flexible, see-through, air-tight seal which is placed on top of food in a storage container and pressed down to smooth out all the bubbles visible between the seal and the food and the edges of the seal flexibly conform to the shape and size of the container at the level of the top of the food so that the seal is usable on containers which change size or shape from top to bottom.

2. Description of the Prior Art

Air tight food storage is important for health reasons to prevent food contamination and spoilage which is largely caused by airborne contaminants and by the oxidation of the food due to prolonged exposure to the air and for economic reasons to prolong the life of the food and prevent spoilage. It is claimed that in the U.S. alone people throw away enough food to feed a large percentage of the people in underdeveloped countries.

When food is packaged either the food fills the container right up to the air tight lid or the space between the food and the air tight lid is evacuated of air to provide an air tight container. This gives food a substantial shelf life, even when not refrigerated. After the container is opened and a portion of the food consumed, the label on the container recommends refrigeration to try and preserve the remaining food in the container.

Most food containers kept in the home, including Tupperware and others, have solid walls and solid covers so that if the food placed in the container fills the container completely it will not be exposed to air and thereby preserve the food for longer use. But that is usually not the case. Whether in the store food container or our own food storage containers, usually there is an air space in the container after a portion of the food is consumed.

Many food containers have changing dimensions or shapes from the top to the bottom of the container primarily for design reasons, therefore rendering inoperable any solid sealing means that one might place on top of the food to eliminate air contacting the food.

Because food surfaces are normally uneven, especially after some of the food has been removed, there is no assurance that any seal over the food will actually eliminate all of the air pockets that tend to form between the food and the seal. With existing food seals, that are rigid and opaque, there is no way to tell if all of the air has been eliminated.

A number of air-sealing containers have been developed, but they typically only work with a uniformly shaped and sized container using a solid air-tight seal on top of the food.

U.S. Pat. No. 5,219,091, issued Jun. 15, 1993 to Paramski, provides a dispensing food container having a cover that is slidable down the container by pressing on the cover to push food contents up through an opening in the cover.

U.S. Pat. No. 3,987,941, issued Oct. 26, 1976 to Blessing, shows a preserving food container for liquid food substances with a follower cover capable of sliding down the container on top of the liquid contained therein to keep out the air with a rubber seal around the cover.

U.S. Pat. No. 1,978,025, issued Oct. 23, 1934 to McCown, claims a coffee can vacuum attachment with a cover that slides down the container to stay in contact with the coffee with a seal around the cover and an air valve in the handle.

U.S. Pat. No. 598,676, issued 28, 1898 to Lochmann, describes a collapsible vessel having two telescoping conical shells one smaller than the other capable of moving down into the larger one on top of food contained in the larger one with a flexible tube interconnecting the two shells to keep the air out.

U.S. Pat. No. 2,763,405, issued Sept. 18, 1956 to Shvetz, discloses a container for flowable semi-solid materials, such as skin creams, having a cover that is slidable down the container on top of the contents with a hole in the cover to push out desired amounts of the contents.

None of the prior art patents solve the problem of ensuring air tight seals on the top of food surfaces in a range of food containers often having varying dimensions and shapes from the top of the container to the bottom.

As indicated none of the patents found in the search should be a problem in terms of patentability or infringement. The flexibility of your food sealing cover to fit a sloping wall container, as well as the transparency to see air bubbles, and the simplicity and low cost provide uniquely patentable features not found in the prior patents.

### SUMMARY OF THE INVENTION

An object of the present invention is to provide a flexible air-tight seal for food storage that conforms to the size and the shape of the food storage container to create an air-tight seal over the food in any food container and at any level in the container, even for containers which change in size or shape from the top to the bottom of the container.

Another object of the present invention is to provide a transparent or translucent see-through seal for food storage that enables the user to see and eliminate air pockets or bubbles that appear between the uneven food surface and the seal, so that the user may smooth out the seal over the food surface to eliminate the air bubbles and create an air-tight seal between the food and the flexible seal.

One more object of the present invention is to provide a precut flexible food seal that is disposable since it may be manufactured easily and cheaply, stacked packaged and sold and used in quantity inexpensively to fit any size food container and be discarded after the food is gone from the container.

In brief, stacked sheets of air-tight flexible see-through (transparent or translucent) material, such as wax paper, waxed paper, parchment paper or plastic wrap or other such material, is cut into shapes, such as circles and squares, common to food storage containers. A die cutter, laser cutter or other means may be used to cut the material. The pre-cut flexible food seals may then be packaged in quantity and sold inexpensively in various sizes and shapes to enables users to buy a quantity of food seals suitable to their needs to help preserve food and provide a longer life for stored food.

A flexible food seal is placed over the top surface of semi-soft and soft foods, such as cottage cheese, sour cream, dips, pudding, frostings, Jell-o, or any other type of food having a malleable surface. The flexible food seal is then pressed down on the food surface with the edges of the food seal evenly positioned over the food surface. The seal is then pressed down and smoothed out over the food surface pushing any air bubbles out to the sides of the food container. The seal is then smoothed around the edges of the food so that the edge portions of the seal contact and conform to the sides of the food container, thereby forming an air-tight seal over the food.

The food may then be stored with or without the usual cover over the food container in the refrigerator or other appropriate storage place for the food.

An advantage of the present invention is that it may be used to preserve and prolong the life of soft and semisoft foods of all types and in all types of food storage containers, including the original jars or containers in which the food was purchased, plastic or glass or other types of food storage containers kept in the home, bowls or glasses or dishes in which food may be stored, or any other type of container that will hold food.

Another advantage of the present invention is that the flexible seals may be shaped to conform to any type of container and bent up at the edges to conform to any size container, including containers that change sizes or shapes from the top to the bottom of the container.

A further advantage of the present invention is that it may be sold with the food in the original container sold in the store and then continually used as the container is emptied of the food over time.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the flexible seal installed at the top of a food container with sloping sides as it might be installed in an original food container sold in a store with the flexible seal pressed down into an air-tight contact with the top surface of the food and the edges of the flexible food seal conforming to the edges of the container where the food meets the container;

FIG. 2 is a perspective view of the flexible seal installed partway down the food container with sloping sides as it might be installed after the food is partially gone from the food container with the flexible seal pressed down into an air-tight contact with the top surface of the food and the edges of the flexible food seal conforming to the edges of the container where the food meets the container and a slight overlap of the flexible food seal extending above the food surface;

FIG. 3 is a perspective view of the flexible seal installed near the bottom of the food container with sloping sides as it might be installed after the food is mostly gone from the food container with the flexible seal pressed down into an air-tight contact with the top surface of the food and the edges of the flexible food seal conforming to the edges of the container where the food meets the container and a large overlap of the flexible food seal extending above the food surface;

FIG. 4 is a side cross sectional view of the flexible seal aligned to be installed partway down the food container with sloping sides after the food is partially gone from the food container;

FIG. 5 is a side cross sectional view of the flexible seal partially installed partway down the food container with sloping sides after the food is partially gone from the food container showing the air bubbles between the uneven top surface of the food and the seal, which air bubbles are visible through the seal and need to be smoothed out from under the seal;

FIG. 6 is a side cross sectional view of the flexible seal installed partway down the food container with sloping sides as it might be installed after the food is partially gone from the food container with the flexible seal pressed down into an air-tight contact with the top surface of the food and the edges of the flexible food seal conforming to the edges of the container where the food meets the container and a slight overlap of the flexible food seal extending above the food surface;

FIG. 7 is a plan view of a

FIG. 8 is a plan view of a stack of flexible food seals cut into circular shapes;

FIG. 9 is a plan view of a single flexible food seal cut into a square shape;

FIG. 10 is a plan view of a stack of flexible food seals cut into square shapes.

### BEST MODE FOR CARRYING OUT THE INVENTION

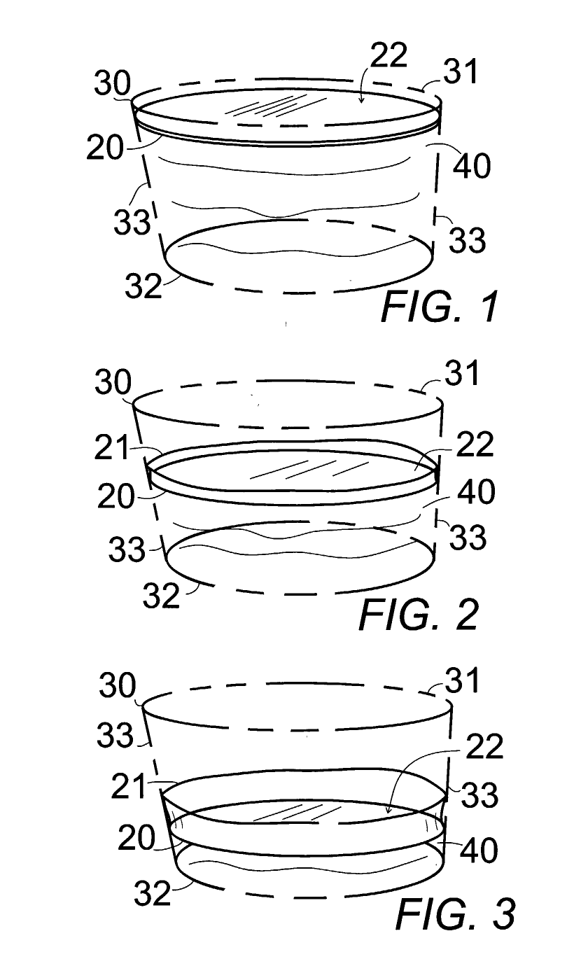

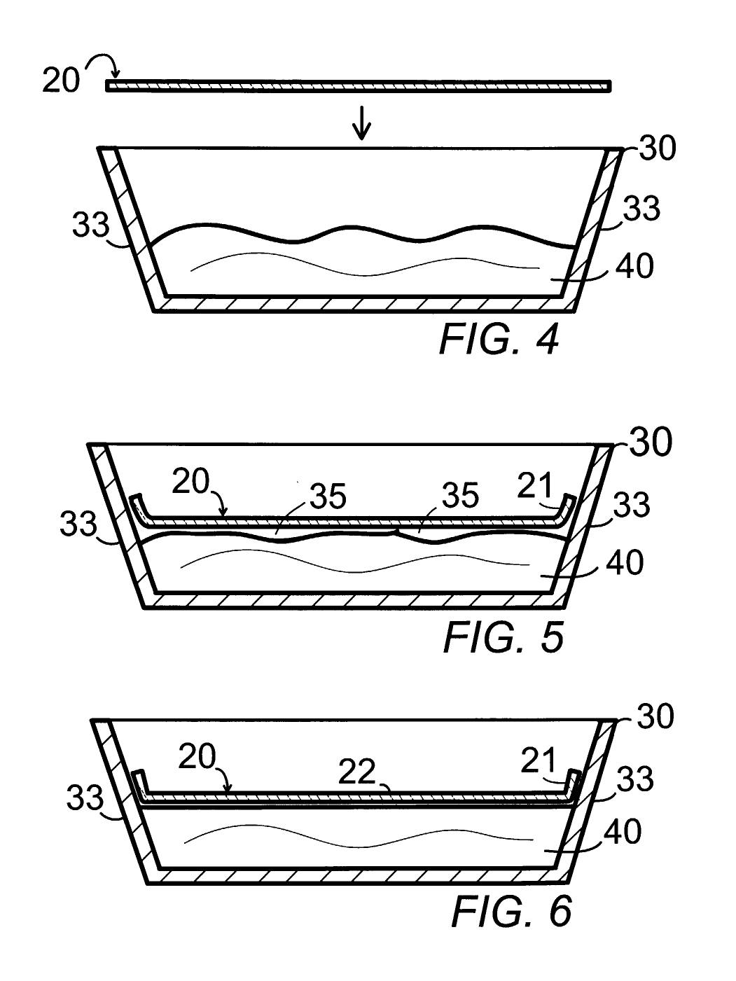

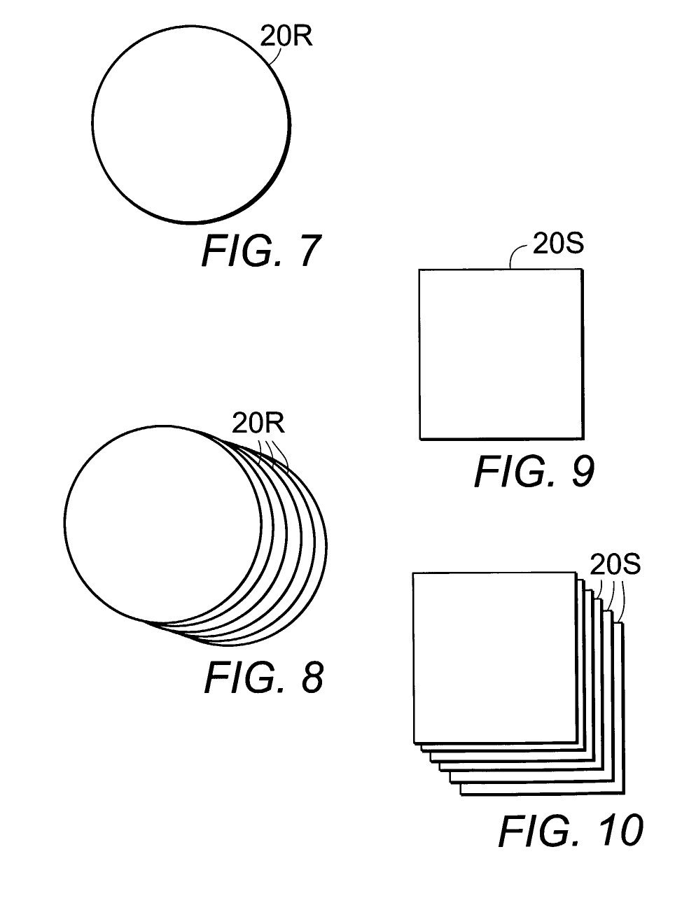

In FIGS. 1-6, a flexible food seal 20 for creating an air-tight seal over food stored in a food storage container 30 comprises a seal 20 formed of flexible air-tight material capable of fitting into a food storage container 30 and conforming to the sides 33 of the food storage container and further capable of covering a top surface of food 40 stored in the container so that the seal is in contact with the top surface of the food with no air space between the food and the seal and no air space between the seal and the sides of the container at any level in the container.

The seal 20 is formed of see-through transparent or translucent material and air bubbles 35, as seen in FIG. 5, between the top surface of the food 40 and the seal 20 are visible through the seal and the seal 20 is capable of being pressed down and smoothed out to remove the air bubbles from between the seal and the food to form an air-tight fit therebetween, as seen in FIG. 6.

The seal 20 is formed of a sufficiently malleable material so that the seal is capable of conforming to the shape of the container 30 at any level in the container, even a container with sloping sides 33 between a top edge 31 and a bottom 32 of the container 30, by bending the edges 21 of the seal to conform to the shape of the container 30 with an air-tight fit therebetween.

The seal 20 is preferably cut from a sheet of wax paper and may also be cut from a sheet of waxed paper, parchment paper, clear plastic wrap or other flexible, malleable, air-tight see-through material, which should also have moisture resistant qualities since most foods container moisture.

In FIGS. 8 and 10 a number of seals 20 may cut simultaneously from a stack of sheets of flexible material by using a cutting die, a laser cutter, or other cutting means used in mass production cutting. The stack of seals may then be packaged and sold in quantity for a reasonable price.

The preferred shapes of the seals are those shapes which conform to most food containers, such as a round seal 20R in FIG. 8 or a square seal 20S in FIG. 9.

In use, a method of preserving food using a flexible food seal 20 for creating an air-tight seal over food stored in a food storage container 30 comprises the step of cutting a seal 20 from a sheet of flexible and malleable air-tight material capable of fitting into a food storage container 30 and conforming to the sides of the food storage container and the step of covering a top surface of food 40 stored in the container 30 with the seal surface 22 above the food is smoothed out so that the seal is in contact with the top surface of the food with no air space between the food and the seal, as seen in FIG. 6, and no air space between the seal and the sides of the container at any level in the container.

The step of cutting the seal from a sheet further comprises cutting the seal from a sheet of see-through transparent or translucent material so that air bubbles 35 between the top surface of the food 40 and the seal 20, as seen in FIG. 5, are visible through the seal and further comprising the step of pressing down on the seal and smoothing out the seal surface 22 above the food to remove the air bubbles from between the seal and the food to form an air-tight fit therebetween, as seen in FIG. 6.

The step of cutting the seal 20 from a sheet further comprises cutting the seal from a sheet of a sufficiently malleable material so that the seal 20 is capable of conforming to the shape of the container 30 at any level in the container, even a container with sloping walls 33 or changing shape from the top edge 31 to the bottom 32 of the container, and further comprising the step of bending the edges 21 of the seal to conform to the shape of the container with an air-tight fit therebetween as seen in FIG. 6.

The preferred step of cutting the seal comprises cutting the seal 20 from a sheet of wax paper. Other options are cutting the seal from a sheet of waxed paper, parchment paper, plastic wrap or other flexible, malleable, air-tight, see-through, and water-resistant material.

The step of cutting the seal 20 preferably comprises cutting a number of seals simultaneously from a stack of sheets of flexible material by using a cutting die, a laser cutter, or other cutting devices used in mass production.

It is understood that the preceding description is given merely by way of illustration and not in limitation of the invention and that various modifications may be made thereto without departing from the spirit of the invention as claimed.

What is claimed is:

1. A flexible food seal for creating an air-tight seal over food stored in a food storage container, the seal comprising:
a seal formed of flexible air-tight material capable of fitting into a food storage container and conforming to the sides of the food storage container and further capable of covering a top surface of food stored in the container so that the seal is in contact with the top surface of the food with no air space between the food and the seal and no air space between the seal and the sides of the container at any level in the container.

2. The seal of claim 1 wherein the seal is formed of transparent material and air bubbles between the top surface of the food and the seal are visible through the seal and the seal is capable of being pressed down and smoothed out to remove the air bubbles from between the seal and the food to form an air-tight fit therebetween.

3. The seal of claim 1 wherein the seal is formed of translucent material and air bubbles between the top surface of the food and the seal are visible through the seal and the seal is capable of being pressed down and smoothed out to remove the air bubbles from between the seal and the food to form an air-tight fit therebetween.

4. The seal of claim 1 wherein the seal is formed of a sufficiently malleable material so that the seal is capable of conforming to the shape of the container at any level in the container by bending the edges of the seal to conform to the shape of the container with an air-tight fit therebetween.

5. The seal of claim 1 wherein the seal is cut from a sheet of wax paper.

6. The seal of claim 1 wherein the seal is cut from a sheet of plastic wrap.

7. The seal of claim 1 wherein the seal is cut from a sheet of waxed paper.

8. The seal of claim 1 wherein the seal is cut from a sheet of parchment paper.

9. The seal of claim 1 wherein a number of seals are cut simultaneously from a stack of sheets of flexible material by using a cutting die.

10. The seal of claim 1 wherein a number of seals are cut simultaneously from a stack of sheets of flexible material by using a laser cutter.

11. A method of preserving food using a flexible food seal for creating an air-tight seal over food stored in a food storage container, the method comprising:
the step of cutting a seal from a sheet of flexible air-tight material capable of fitting into a food storage container and conforming to the sides of the food storage container;
the step of covering a top surface of food stored in the container so that the seal is in contact with the top surface of the food with no air space between the food and the seal and no air space between the seal and the sides of the container at any level in the container.

12. The method of claim 11 wherein the step of cutting the seal from a sheet further comprises cutting the seal from a sheet of transparent material so that air bubbles between the top surface of the food and the seal are visible through the seal and further comprising the step of pressing down on the seal and smoothing out the seal to remove the air bubbles from between the seal and the food to form an air-tight fit therebetween.

13. The method of claim 11 wherein the step of cutting the seal from a sheet further comprises cutting the seal from a sheet of translucent material so that air bubbles between the top surface of the food and the seal are visible through the seal and further comprising the step of pressing down on the seal and smoothing out the seal to remove the air bubbles from between the seal and the food to form an air-tight fit therebetween.

14. The method of claim 11 wherein the step of cutting the seal from a sheet further comprises cutting the seal from a sheet of a sufficiently malleable material so that the seal is capable of conforming to the shape of the container at any level in the container, and further comprising the step of bending the edges of the seal to conform to the shape of the container with an air-tight fit therebetween.

15. The method of claim 11 wherein the step of cutting the seal comprises cutting the seal from a sheet of wax paper.

16. The method of claim 11 wherein the step of cutting the seal comprises cutting the seal from a sheet of plastic wrap.

17. The method of claim 11 wherein the step of cutting the seal comprises cutting the seal from a sheet of waxed paper.

18. The method of claim 11 wherein the step of cutting the seal comprises cutting the seal from a sheet of parchment paper.

19. The seal of claim 11 wherein the step of cutting the seal comprises cutting a number of seals simultaneously from a stack of sheets of flexible material by using a cutting die.

20. The seal of claim 11 wherein the step of cutting the seal comprises cutting a number of seals simultaneously from a stack of sheets of flexible material by using a laser cutter.
